(19) United States
(12) Patent Application Publication
(10) Pub. No.: US 2012/0077485 A1
(43) Pub. Date: Mar. 29, 2012

(54) METHOD AND APPARATUS FOR DETERMINING DOWNLINK BEAMFORMING VECTORS IN HIERARCHICAL CELL COMMUNICATION SYSTEM

(76) Inventors: Won Jae Shin, Yongin-si (KR); Nam Yoon Lee, Seoul (KR); Won Jong Noh, Yongin-si (KR); Young Jun Hong, Seoul (KR); Hyun Ho Choi, Suwon-si (KR); Chang Yong Shin, Seoul (KR); Kyung Hun Jang, Suwon-si (KR)

(21) Appl. No.: 13/236,333

(22) Filed: Sep. 19, 2011

(30) Foreign Application Priority Data
Sep. 29, 2010 (KR) 10-2010-0094295

(51) Int. Cl. H04W 4/00

(52) U.S. Cl. 455/422.1

(57) ABSTRACT

Provided is a method and apparatus for determining a downlink beamforming vector in a hierarchical cell communication system. Small base stations may determine transmit beamforming vectors of the small base stations so that interference from the small base stations may be reduced in a macro terminal. A macro terminal and small terminals may determine receive beamforming vectors based on the transmit beamforming vectors of the small base stations. A macro base station may determine a transmit beamforming vector based on effective channels to terminals using the receive beamforming vectors of the terminals.

### CROSS-REFERENCE TO RELATED APPLICATION(S)

This application claims the benefit under 35 U.S.C. §119(a) of Korean Patent Application No. 10-2010-0094295, filed on Sep. 29, 2010, in the Korean Intellectual Property Office, the entire disclosure of which is incorporated herein by reference for all purposes.

### BACKGROUND

1. Field

The following description relates to a hierarchical cell communication system, and more particularly, to a method and apparatus for determining a downlink transmit beamforming vector and a downlink receive beamforming vector for wireless communication.

2. Description of Related Art

Because of the variety of radio communication technologies and equipments, the demand for radio communication resources is rapidly increasing. This increase in demand results in a shortage of limited frequency resources. Therefore, there is a need for technology for more effectively using frequency resources.

A hierarchical cell environment indicates an environment in which small cells formed by small base stations within a macro cell are constructed as a self-organizing network form. Examples of a small cell include a relay cell, a femto cell, a pico cell, a cell by home node-B (HNB), a cell by home enhanced node-B (HeNB), a cell by remote radio head (RRH), and the like.

The hierarchical cell environment enables the total system capacity to increase. However, a quality of service (QoS) for a user may deteriorate because of interference between a macro base station and a small base station. Accordingly, there is a desire to effectively manage interference between a macro cell and a small cell.

### SUMMARY

In one general aspect, there is provided a communication method of a macro base station, the communication method including obtaining information associated with a first small effective channel formed between a first small terminal corresponding to a first small base station and a macro base station, obtaining information associated with a second small effective channel formed between a second small terminal corresponding to a second small base station and the macro base station, and determining a transmit beamforming vector of the macro base station based on information associated with the first small effective channel and information associated with the second small effective channel, wherein a receive beamforming vector of each of the at least one macro terminal is determined based on the transmit beamforming vector of the first small base station and the transmit beamforming vector of the second small base station.

The determining may comprise determining the transmit beamforming vector of the macro base station based on information associated with the first small effective channel and information associated with the second small effective channel, such that interference from the macro base station is nulled in each of the first small terminal and the second small terminal.

The communication method may further comprise receiving information associated with a first macro effective channel formed between a first macro terminal and the macro base station, and information associated with a second macro effective channel formed between a second macro terminal and the macro base station, wherein the first macro effective channel is associated with a receive beamforming vector of the first macro terminal and the second macro effective channel is associated with a receive beamforming vector of the second macro terminal, and the determining may comprise determining the transmit beamforming vector of the macro base station based on information associated with the first macro effective channel and information associated with the second macro effective channel, such that interference from the macro base station caused by a signal for the second macro terminal is nulled in the first macro terminal and such that interference from the macro base station caused by a signal for the first macro terminal is nulled in the second macro terminal.

The communication method may further comprise obtaining information associated with an effective channel that is formed between a neighboring macro terminal corresponding to a neighboring macro base station and the macro base station, wherein the effective channel is associated with a receive beamforming vector of the neighboring macro terminal, and the determining may comprise determining the transmit beamforming vector of the macro base station based on information associated with the effective channel formed between the macro base station and the neighboring macro terminal, such that interference from the macro base station to the neighboring macro terminal is nulled in the neighboring macro terminal.

The receive beamforming vector of each of the at least one macro terminal may be determined based on the transmit beamforming vector of the first small base station and the transmit beamforming vector of the second small base station, such that interference from the first small base station and the second small base station is nulled in each of the at least one macro terminal.

The communication method may further comprise receiving information associated with channels formed between each of the first small base station and the second small base station and each of the at least one macro terminal, and transferring, to the first small base station and the second small base station, information associated with the channels formed between each of the first small base station and the second small base station and each of the at least one macro terminal.

In another aspect, there is provided a communication method of a macro terminal corresponding to a macro base station, the communication method including feeding back information associated with a first interference channel formed between a first small base station and the macro terminal, and a second interference channel formed between a second small base station and the macro terminal, determining a receive beamforming vector of the macro terminal based on a transmit beamforming vector of the first small base station and a transmit beamforming vector of the second small base station, calculating an effective channel formed between the macro base station and the macro terminal based on the receive beamforming vector of the macro terminal, and feeding back, to the macro base station, information associated with the effective channel formed between the macro base station and the macro terminal.

The feeding back may comprise feeding back information in which information associated with the first interference channel and information associated with the second interference channel are combined.

The feeding back may comprise feeding back, to the macro base station, information associated with the first interference channel and the second interference channel such that information associated with the first interference channel and the second interference channel are transferred to the first small base station and the second small base station.

The communication method may further comprise receiving information associated with the transmit beamforming vector of the first small base station and information associated with the transmit beamforming vector of the second small base station, wherein the transmit beamforming vector of the first small base station and the transmit beamforming vector of the second small base station are determined such that interference from the first small base station and interference from the second small base station are aligned in the macro terminal.

The determining may comprise determining the receive beamforming vector of the macro terminal such that interference from the first small base station is cancelled in the macro terminal based on the transmit beamforming vector of the first small base station and the first interference channel, and such that interference from the second small base station is cancelled in the macro terminal based on the transmit beamforming vector of the second small base station and the second interference channel.

The determining may comprise determining the receive beamforming vector of the macro terminal to be orthogonal with respect to a direction of the interference from the first small base station and a direction of the interference from the second small base station.

In another aspect, there is provided a macro base station, including a receiver to obtain information associated with a first small effective channel formed between a first small terminal corresponding to a first small base station and a macro base station, and to obtain information associated with a second small effective channel formed between a second small terminal corresponding to a second small base station and the macro base station, and a transmit beamforming vector determining unit to determine a transmit beamforming vector of the macro base station based on information associated with the first small effective channel and information associated with the second small effective channel, wherein a receive beamforming vector of each of the at least one macro terminal is determined based on the transmit beamforming vector of the first small base station and the transmit beamforming vector of the second small base station.

The transmit beamforming vector determining unit may be configured to determine the transmit beamforming vector of the macro base station based on information associated with the first small effective channel and information associated with the second small effective channel, such that interference from the macro base station is nulled in each of the first small terminal and the second small terminal.

If the at least one macro terminal comprises a first macro terminal and a second macro terminal, the receiver may be configured to receive information associated with a first macro effective channel formed between the first macro terminal and the macro base station, and information associated with a second macro effective channel formed between the second macro terminal and the macro base station, the first macro effective channel is associated with a receive beamforming vector of the first macro terminal and the second macro effective channel is associated with a receive beamforming vector of the second macro terminal, and the transmit beamforming vector determining unit may be configured to determine the transmit beamforming vector of the macro base station based on information associated with the first macro effective channel and information associated with the second macro effective channel, such that interference from the macro base station occurring due to a signal for the second macro terminal is nulled in the first macro terminal and such that interference from the macro base station occurring due to a signal for the first macro terminal is nulled in the second macro terminal.

The receiver may be configured to obtain information associated with an effective channel formed between a neighboring macro terminal corresponding to a neighboring macro base station and the macro base station, and the effective channel is associated with a receive beamforming vector of the neighboring macro terminal, and the transmit beamforming vector determining unit may be configured to determine the transmit beamforming vector of the macro base station based on information associated with the effective channel formed between the macro base station and the neighboring macro terminal, such that interference from the macro base station to the neighboring macro terminal is nulled in the neighboring macro terminal.

The receive beamforming vector of each of the at least one macro terminal may be determined based on the transmit beamforming vector of the first small base station and the transmit beamforming vector of the second small base station, such that interference from the first small base station and the second small base station is nulled in each of the at least one macro terminal.

The receiver may be configured to receive information associated with channels formed between each of the first small base station and the second small base station and each of the at least one macro terminal, and the macro base station may further comprise a transfer unit to transfer, to the first small base station and the second small base station, information associated with the channels formed between each of the first small base station and the second small base station and each of the at least one macro terminal.

In another aspect, there is provided a communication method of a targeted small terminal corresponding to a targeted small base station, the communication method including obtaining information associated with an effective channel from a macro base station to the targeted small terminal based on a transmit beamforming vector of the macro base station, and information associated with a channel from a neighboring small base station to the targeted small terminal, determining a transmit beamforming vector of the neighboring small base station such that interference from the macro base station and interference from the neighboring small base station are aligned in the targeted small terminal, and determining a receive beamforming vector of the targeted small terminal such that interference from the macro base station is nulled in the targeted small terminal.

The determining of the transmit beamforming vector of the neighboring small base station may comprise determining the transmit beamforming vector of the neighboring small base station based on the same codebook as a codebook used to generate the transmit beamforming vector of the macro base station, and the determining of the receive beamforming vector of the targeted small base station may comprise determining the receive beamforming vector of the targeted small terminal based on the same codebook as the codebook used to generate the transmit beamforming vector of the macro base station.

Other features and aspects may be apparent from the following detailed description, the drawings, and the claims.

### BRIEF DESCRIPTION OF THE DRAWINGS

FIG. 1 is a diagram illustrating an example of a hierarchical cell communication system.

FIG. 2 is a diagram illustrating an example of a hierarchical cell communication system that performs a method of determining a transmit beamforming vector and a receive beamforming vector.

FIG. 3 is a diagram illustrating an example of a hierarchical cell communication system in which at least two macro cells perform a method of determining a transmit beamforming vector and a receive beamforming vector.

FIG. 4 is a flowchart illustrating an example of a communication method of a macro base station.

FIG. 5 is a flowchart illustrating an example of a communication method of a macro terminal.

FIG. 6 is a diagram illustrating an example of a macro base station.

FIG. 7 is a diagram illustrating an example of a macro terminal.

FIG. 8 is a diagram illustrating an example of a hierarchical cell communication system in which interference from pico base stations to a macro terminal is weak.

FIG. 9 is a diagram illustrating an example of a signal transmission process of a hierarchical cell communication system in which interference from pico base stations to a macro terminal is weak.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, description of well-known functions and constructions may be omitted for increased clarity and conciseness.

Various aspects relate to a method of generating transmit beamforming vectors and receive beamforming vectors that are capable of achieving a communication performance similar to a method of feeding backing full channel information. However, as described herein, a relatively smaller amount of feedback information associated with a channel in a hierarchical cell communication environment is fed back.

Hereinafter, assumptions may be made for ease of description. However, the assumptions do not limit the scope of the description. For example, even though a number of base stations, a number of terminals, a number of antennas, and the like are described, the examples described herein are not limited thereto. In addition, the assumptions may be similar to an environment used in a next generation mobile communication standardization organization and the like, for example, a long term evolved (LTE)-advanced standardization.

As described herein, a small cell may include a relay cell, a femto cell, a pico cell, a cell by home node-B (HNB), a cell by home enhanced node-B (HeNB), a cell by remote radio head (RRH), and the like.

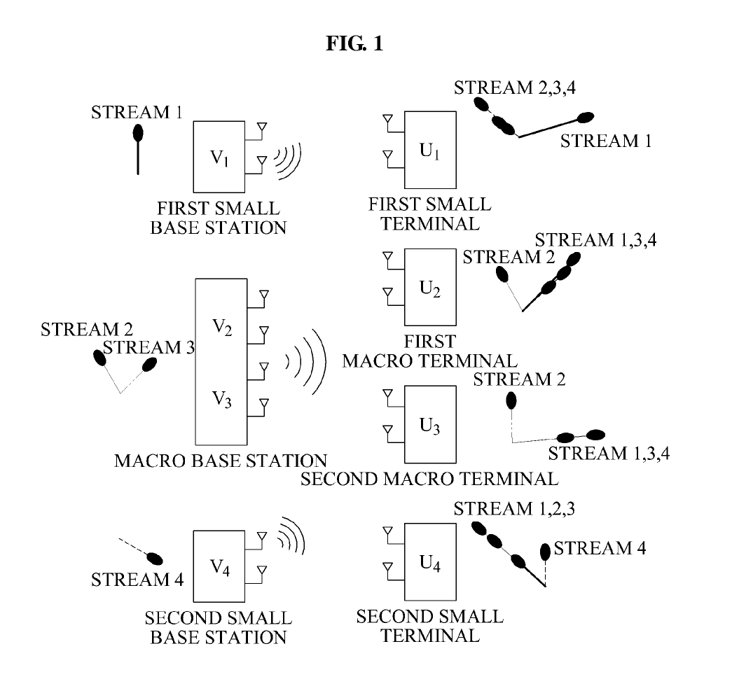

FIG. 1 illustrates an example of a hierarchical cell communication system.

Referring to FIG. 1, one or more small cells may be located within the coverage of a macro base station (i.e. within the coverage of a macro cell). In this example, two small cells are within the macro cell. For example, the macro cell may operate as a multi-user multiple-input multiple-output (MU-MIMO) communication system that simultaneously serves one or more macro terminals. In this example, the macro cell serves two macro terminals, a first macro terminal and a second macro terminal. The macro base station may have one or more antennas, for example, two antennas, four antennas, six antennas, eight antennas, or more antennas. In this example, the macro base station includes four antennas.

The two small cells may operate as a single-user multiple-input multiple-output (SU-MIMO) communication system in which small base stations, for example, a first small base station and a second small base station serve single small terminals, for example, a first small terminal and a second small terminal, respectively. A small base station may have one or more antennas, for example, one antenna, two antennas, four antennas, for more. In this example, each of the first small base station and the second small base station may have two antennas. Because a small cell is generally manufactured with relatively smaller costs, a number of antennas installed in a small base station may be less than a number of antennas installed in a macro base station.

In this example, each of the terminals, for example, each of macro terminals and small terminals, have two antennas. Accordingly, each of the terminals may have a two-dimensional (2D) signal space. For example, each terminal may receive a single stream from a base station serving each respective terminal using a single signal space, and may align inter-cell interference and intra cell interference using another signal space. By doing so, each of the terminals may completely receive a single stream.

A signal transmitted from each base station for each terminal may be expressed by Equation 1.

xᵢ=\sqrt{pᵢ}vᵢsᵢ [Equation 1]

In Equation 1, i=1, 2, 3, 4, and i corresponds to a terminal index. In this example, the first small terminal, the first macro terminal, the second macro terminal, and the second small terminal correspond to index 1, 2, 3, and 4, respectively. In this example, sᵢ corresponds to a transmission stream, and vᵢ corresponds to a transmit beamforming vector and a unit norm vector, for example, ∥vᵢ∥₂=1. Furthermore, in this example, pᵢ corresponds to a transmit power of a data stream.

A signal received by each terminal may be expressed as follows. Initially, a signal y₁ received by the first small terminal may be expressed by Equation 2.

$${y}_{1} = {H}_{11} \sqrt{{p}_{1}} {v}_{1} {s}_{1} + \underbrace{{\sum }_{i = 2}^{3} {H}_{12} \sqrt{{p}_{i}} {v}_{i} {s}_{i}}_{{other \text{-} cell interference}_{( macro cell )}} + \underbrace{{H}_{13} \sqrt{{p}_{3}} {v}_{3} {s}_{3}}_{{other \text{-} cell interference}_{( second small cell )}} + {n}_{1} \qquad [ Equation 2 ]$$

A signal y₂ received by the first macro terminal and a signal y₃ received by the second macro terminal may be expressed by Equation 3.

$${y}_{i}^{macro} = {H}_{i 2} \sqrt{{p}_{i}} {v}_{i} {s}_{i} + \underbrace{{H}_{12} \sqrt{{p}_{k}} {v}_{k} {s}_{k}}_{{other \text{-} cell interference}_{( macro cell )}} + \underbrace{{\sum }_{j = 1 , j \neq 2}^{3} {H}_{ij} \sqrt{{p}_{j}} {v}_{j} {s}_{j}}_{{other \text{-} cell interference}_{( small cell )}} + {n}_{i} \qquad [ Equation 3 ]$$

where i, īε{2,3}, ī≠i

A signal y₄ received by the second small terminal may be expressed by Equation 4.

$${y}_{4} = {H}_{43} \sqrt{{p}_{4}} {v}_{4} {s}_{4} + \underbrace{{\sum }_{i = 2}^{3} {H}_{12} \sqrt{{p}_{i}} {v}_{i} {s}_{i}}_{{other \text{-} cell interference}_{( macro cell )}} + \underbrace{{H}_{31} \sqrt{{p}_{1}} {v}_{1} {s}_{1}}_{{other \text{-} cell interference}_{( first small cell )}} + {n}_{4} \qquad [ Equation 4 ]$$

In Equation 4, Hᵢⱼ corresponds to a channel matrix between a j^{th} base station and an i^{th} terminal, and nᵢ corresponds to additive white Gaussian noise (AWGN) added to the i^{th} terminal. In this example, each of the terminals may obtain an effective signal using a receive beamforming vector uᵢ^{H} of each of the terminals.

A process of determining transmit beamforming vectors and receive beamforming vectors of a macro cell and small cells in a system model of FIG. 1 is further described herein.

First, each small base station may receive information that is associated with interference channels from each small base station to each macro terminal. For example, the first small base station may receive combined information that is associated with interference channels of macro terminals, instead of receiving information H₂₁, H₂₃, H₃₃, and H₃₁ associated with all the interference channels from the small base stations to the macro terminals. For example, the first small base station may receive (H₂₁)⁻¹H₂₃ from the first macro terminal, and may receive (H₃₃)⁻¹H₃₁ from the second macro terminal. As another example, the second small base station may receive (H₂₁)⁻¹H₂₃ and (H₃₃)⁻¹H₃₁. For example, the feedback information may be transferred from the macro terminals to the first small base station and the second base station via the macro base station.

Second, the first small base station and the second small base station may determine a transmit beamforming vector v₁ of the first small base station and a transmit beamforming vector v₂ of the second small base station such that interference from the first small base station and interference from the second small base station are aligned in each macro terminal.

An example of a method of determining a transmit beamforming vector of small base stations is described using the following equations.

H₂₁v₁=αH₂₃v₄

H₃₁v₁=βH₃₃v₄ [Equation 5]

Equation 5 may be arranged to Equation 6.

$${H}_{31} ( {α ( {H}_{21} )}^{- 1} {H}_{23} {v}_{4} ) = β {H}_{33} {v}_{4} \\ ⇔ \underbrace{{H}_{31} {α ( {H}_{21} )}^{- 1} {H}_{23}}_{A} \underbrace{{v}_{4}}_{x} = β \underbrace{{H}_{33}}_{B} \underbrace{{v}_{4}}_{x} \\ ⇔ A x = λ Bx \qquad [ Equation 6 ]$$

According to a Rayleigh-Ritz method, a transmit beamforming vector v₄ of the second small base station may be determined according to Equation 7.

$${( {H}_{33} )}^{- 1} {{H}_{31} ( {H}_{21} )}^{- 1} {H}_{23} {v}_{4} = \frac{β}{α} {v}_{4} \\ ∴ {v}_{4} = eig ( {( {H}_{33} )}^{- 1} {{H}_{31} ( {H}_{21} )}^{- 1} {H}_{23} ) \qquad [ Equation 7 ]$$

where eig(A) denote a eigenvector of A

For example, Equation 7 may be used to calculate an eigenvector of a 2×2 matrix. If the 2×2 matrix includes independent columns, two eigenvectors may exist.

By substituting Equation 5 with v₄, a transmit beamforming vector v₁ of the first small base station may be obtained as shown in Equation 8.

∴v₁=ρ(H₂₁)⁻¹H₂₃v₄ [Equation 8]

where ρ is the constant to normalize |v₁|²

In an example in which a small base station receives information H₂₁, H₂₃, H₃₃, and H₃₁ associated with all the interference channels from the small base stations to macro terminals, an eigenvector with relatively great gain in an aspect of a sum throughput may be determined as v₄. However, according to various aspects described herein, if the first macro terminal and the second macro terminal feed back (H₂₁)⁻¹H₂₃ and (H₃₃)⁻¹H₃₁, any of two eigenvectors may be selected as v₄.

Third, the terminals may determine receive beamforming vectors u₁, u₂, u₃, and u₄ of the terminals based on interference that occurs due to transmit beamforming vector of the small base stations. Because the transmit beamforming vectors of the small base stations are already determined, each of the terminals may determine a receive beamforming vector uᵢ^{H} to cancel or otherwise reduce interference based on the transmit beamforming vectors of the small base stations and interference channel information.

For example, the first macro terminal may determine u₂ as (H₂₁v₁)^{⊥} that is in an orthogonal direction with respect to H₂₁v₁ in which interference from the first small base station and interference from the second small base station are aligned. Similarly, the second macro terminal may also determine u₃ using the same method.

As another example, the first small terminal may determine u₁ as (H₁₃v₄)^{⊥} that is in an orthogonal direction with respect to H₁₃v₄ that is a direction of interference from the second small base station. Similarly, the second small terminal may also determine u₄ using the same method.

Even though a method of determining the receive beamforming vectors using a direction orthogonal to a direction of interference is described, various aspects may be applicable to a method of determining, as a receive beamforming vector, a minimum mean square error (MMSE) filter based on noise.

Fourth, each of the terminals may calculate an effective channel from a macro base station to each terminal, based on a receive beamforming vector of each terminal. In this example, each of the terminals may feed back, to the macro base station, information that is associated with the effective channel.

In a conventional method, each terminal may feed back Hᵢ₂. In this example, i corresponds to a terminal index, i=1, 2, 3, and 4, and Hᵢ₂ corresponds to a 2×4 matrix. However, as described in various aspects herein, each terminal may feed back, to the macro base station, wᵢ^{H}Hᵢ₂ information associated with an effective channel from the macro base station based on the receive beamforming vector of each terminal. In this example, i corresponds to a terminal index, i=1, 2, 3, and 4, and Hᵢ₂ corresponds to a 1×4 matrix. Accordingly, it is possible to significantly decrease a feedback overhead.

Fifth, the macro base station may determine transmit beamforming vectors v₂ and v₃ of the macro base station. The macro base station may determine the transmit beamforming vectors based on the receive beamforming vectors of each macro terminal. For example, the macro base station may determine the transmit beamforming vectors of the macro base station such that effective channels from the macro base station to each small terminal may be nulled in each macro terminal, and such that an effective channel from the macro base station to another macro terminal may be nulled in each macro terminal. In various aspects, the transmit beamforming vector of the macro base station may be determined based on an amount of noise instead of being determined such that the effective channels may be nulled.

A method of determining the transmit beamforming vectors of the macro base station is expressed by Equation 9.

vᵢ=null([u₁^{H}H₁₂u₄^{H}H₄₂uⱼ^{H}Hⱼ₂]) [Equation 9]

where i, jε{2,3}, j≠i,
null(A) is the vector in null space of A with unit norm

Equation 9 may be arranged to Equation 10.

$${v}_{i} = null ( \underbrace{[ \begin{matrix}{u}_{1}^{H} {H}_{12} & {u}_{4}^{H} {H}_{42} & {u}_{j}^{H} {H}_{j 2}\end{matrix} ]}_{{H}_{eff}} ) = null ( {H}_{eff} ) \\ ⇔ {v}_{i} = {\overline{v}}_{4} \\ where \\ \begin{matrix}{H}_{eff} = {\overline{U}}^{H} \overline{Σ} \overline{V} ( SVD decomposition ) \\ = [ \begin{matrix}{\overline{u}}_{1} & {\overline{u}}_{2} & {\overline{u}}_{3}\end{matrix} ] [ \begin{matrix}{\overline{λ}}_{1} & 0 & 0 & 0 \\ 0 & {\overline{λ}}_{2} & 0 & 0 \\ 0 & 0 & {\overline{λ}}_{3} & 0\end{matrix} ] [ \begin{matrix}{\overline{v}}_{1} & {\overline{v}}_{2} & {\overline{v}}_{3} & {\overline{v}}_{4}\end{matrix} ]\end{matrix} \qquad [ Equation 10 ]$$

Accordingly, the macro base station may determine the transmit beamforming vectors of the macro base station using the method described with reference to FIG. 1.

In another aspect, a method of determining transmit beamforming vectors and receive beamforming vectors such that each terminal may receive each single stream is described. An example of an amount of channel information to be fed back with respect to a degree of freedom (DOF) is shown in Table 1.

TABLE 1

| | | Number of feedback |
|---|---|---|
| | DOF | information |
| TDMA | 8/3 | (2 × 2): two |
| (Existing) | | (2 × 4): two |
| Hierarchical IA 1 | 4 | (2 × 2): two |
| (Example) | | (1 × 4): four |
| Hierarchical IA 2 | 4 | (2 × 2): four |
| (Example) | | (1 × 4): four |
| IA | 4 | (2 × 2): eight |
| (Existing) | | (2 × 4): four |

In Table 1, IA indicates interference aligning. For example, a hierarchical interference alignment method may be classified into hierarchical IA 1 and hierarchical IA 2. In this example, hierarchical IA 1 corresponds to a method that does not feed back interference channel information from small base stations to macro base stations. Hierarchical IA 2 corresponds to a method that calculates an eigenvector of Equation 7 based on interference channel information from the small base stations to the macro base stations. Hierarchical IA 1 may achieve a performance that is proximate to a case in which full channel information is fed back based on a relatively small amount of feedback.

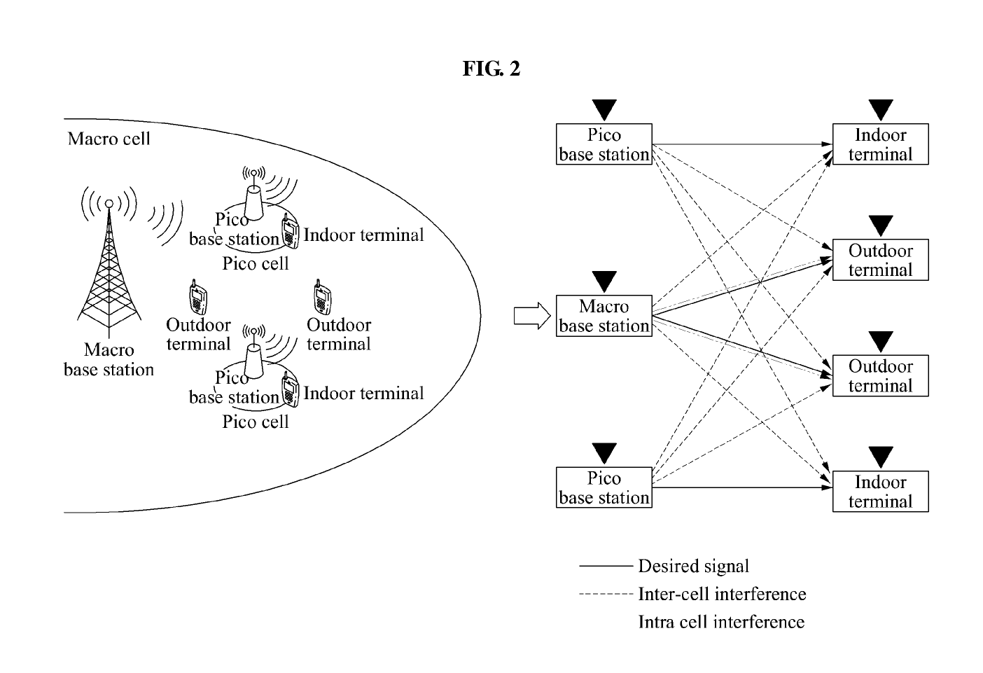

FIG. 2 illustrates an example of a hierarchical cell communication system that performs a method of determining a transmit beamforming vector and a receive beamforming vector.

Referring to FIG. 2, two pico cells are present within a macro cell. For example, a macro base station may service an outdoor terminal. As another example, a pico base station within a pico cell may service an indoor terminal. By determining the transmit beamforming vectors of the macro base station and each pico base station, and determining receive beamforming vectors of each outdoor terminal and each indoor terminal using the method described with reference to FIG. 1, it is possible to cancel inter-cell interference and intra-cell interference as shown in FIG. 2.

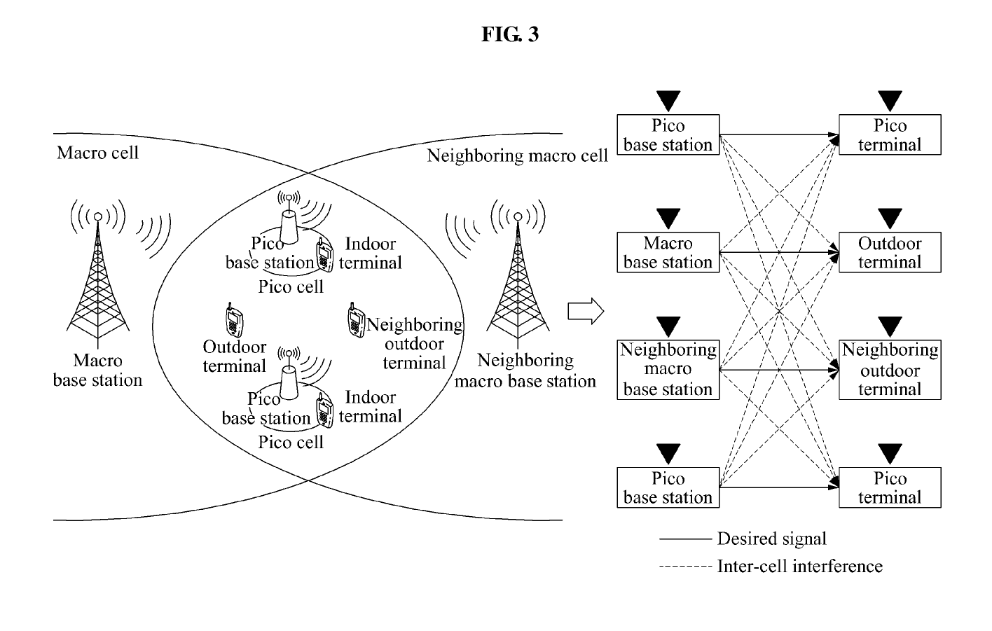

FIG. 3 illustrates an example of a hierarchical cell communication system in which at least two macro cells perform a method of determining a transmit beamforming vector and a receive beamforming vector.

As shown in FIG. 3, a method of determining a transmit beamforming vector and a receive beamforming vector may be applicable to a case in which at least two macro base stations are present. In this example, a macro base station may determine a transmit beamforming vector of the macro base station such that an effective channel from the macro base station to a neighboring outdoor terminal that is served by a neighboring macro base station is nulled.

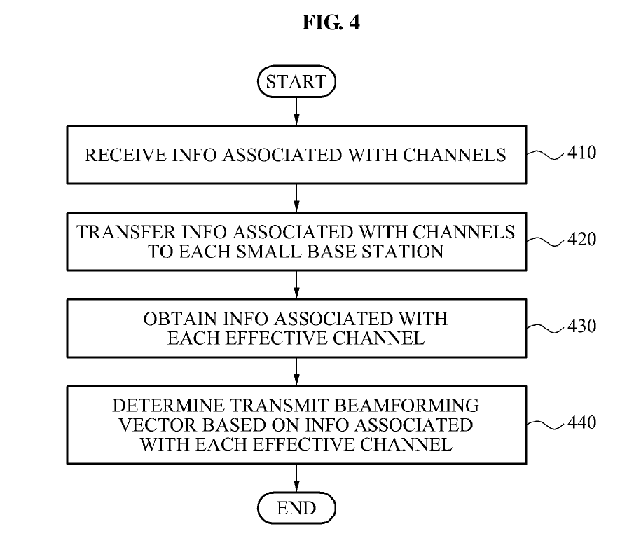

FIG. 4 illustrates an example of a communication method of a macro base station.

Referring to FIG. 4, in 410, the macro base station receives information associated with channels formed between each of a first small base station included in a first small cell and a second small base station included in a second small cell, and each of at least one macro terminals that are served by the macro base station.

In 420, the macro base station transfers, to the first small base station and the second small base station, information that is associated with the channels that are formed between each of the first small base station and the second small base station and each of the at least one macro terminal, so that a transmit beamforming vector of the first small base station and a transmit beamforming vector of the second small base station may be determined.

For example, if the transmit beamforming vector of the first small base station and the transmit beamforming vector of the second small base station are determined such that interference from the first small base station and interference from the second small base station are aligned in each of the at least one macro terminal, in 430 the macro base station obtains information associated with a first small effective channel formed between a first small terminal corresponding to a first small base station and a macro base station, and information associated with a second small effective channel formed between a second small terminal corresponding to a second small base station and a macro base station.

For example, the macro base station may obtain the information associated with the first small effective channel and the information associated with the second small effective channel, from the first small terminal and the second small terminal, respectively. In this example, each of the terminals may feed back, to the macro base station, information that is associated with the effective channel.”

In another aspect, the macro base station may obtain the information from the small terminals via the small base stations, respectively. In this example, the small terminals transmit the information to the corresponding small base stations.

As another example, the macro base station may obtain the information from the small terminals via the macro terminals. In this example, the small terminals transmit the information to the macro terminals.

In this example, the first small effective channel may be associated with a receive beamforming vector of the first small terminal and the second small effective channel may be associated with a receive beamforming vector of the second small base station. The receive beamforming vector of each of the at least one macro terminal may be determined based on the transmit beamforming vector of the first small base station and the transmit beamforming vector of the second small base station.

In 440, the macro base station determines a transmit beamforming vector of the macro base station based on information that is associated with the first small effective channel and information that is associated with the second small effective channel. In this example, the macro base station may determine the transmit beamforming vector such that interference from the macro base station may be nulled in each of the first small terminal and the second small terminal.

For example, if the at least one macro terminal includes a first macro terminal and a second macro terminal, the macro base station may determine the transmit beamforming vector of the macro base station based on the information associated with the first macro effective channel and information associated with the second macro effective channel such that interference from the macro base station that occurs due to a signal for the second macro terminal may be nulled in the first macro terminal and such that interference from the macro base station occurring due to a signal for the first macro terminal may be nulled in the second macro terminal.

Also, the macro base station may determine the transmit beamforming vector of the macro base station based on the information associated with the effective channel formed between the macro base station and the neighboring macro terminal such that interference from the macro base station to the neighboring macro terminal may be nulled in the neighboring macro terminal.

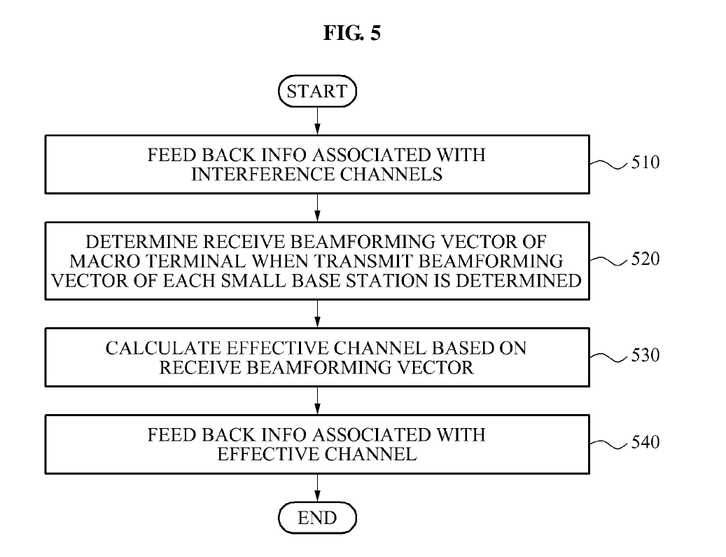

FIG. 5 illustrates an example of a communication method of a macro terminal.

Referring to FIG. 5, in 510, the macro terminal feeds back information associated with a first interference channel that is formed between a first small base station and the macro terminal, and a second interference channel that is formed between a second small base station and the macro terminal. For example, the macro terminal may feed back information in which information associated with the first interference channel and information associated with the second interference channel are combined. In this example, the feedback may be performed via the macro base station, or may be performed directly with respect to the first small base station and the second small base station.

If a transmit beamforming vector of the first small base station and a transmit beamforming vector of the second small base station are determined, the macro terminal may receive information that is associated with the transmit beamforming vector of the first small base station and information associated with the transmit beamforming vector of the second small base station.

For example, the macro base station may transmit, to the macro terminal, the information that is associated with the transmit beamforming vector of the first small base station and information associated with the transmit beamforming vector of the second small base station. In this example, the small base stations transmit information associated with their transmit beamforming vector, respectively.

In another aspect, the first small base station may transmit, to the macro terminal, the information that is associated with the transmit beamforming vector of the first small base station, and the second small base station may transmit, to the macro terminal, the information that is associated with the transmit beamforming vector of the second small base station.

In 520, the macro terminal determines a receive beamforming vector of the macro terminal based on information that is associated with the transmit beamforming vector of the first small base station and information that is associated with the transmit beamforming vector of the second small base station. For example, the macro terminal may determine the receive beamforming vector of the macro terminal such that interference from the first small base station may be cancelled in the macro terminal based on the transmit beamforming vector of the first small base station and the first interference channel, and such that interference from the second small base station may be cancelled in the macro terminal based on the transmit beamforming vector of the second small base station and the second interference channel. In this example, the macro terminal may determine the receive beamforming vector of the macro terminal to be orthogonal with respect to a direction of the interference from the first small base station and a direction of the interference from the second small base station.

In 530, the macro terminal calculates an effective channel formed between the macro base station and the macro terminal based on the receive beamforming vector of the macro terminal.

In 540, the macro terminal feeds back, to the macro base station, information that is associated with the effective channel formed between the macro base station and the macro terminal before the transmit beamforming vector of the macro base station is determined.

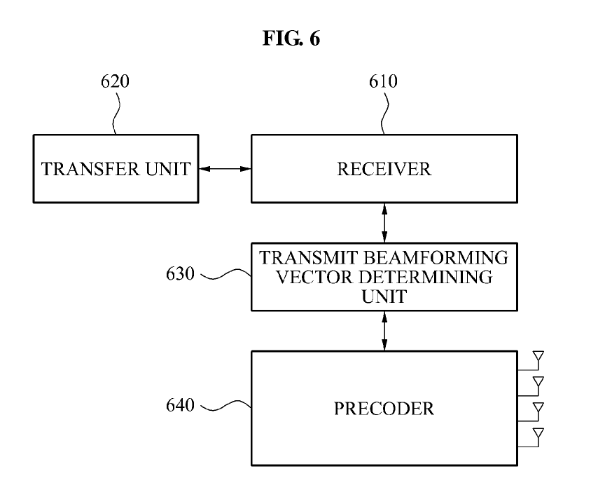

FIG. 6 illustrates an example of a macro base station.

Referring to FIG. 6, the macro base station includes a receiver 610, a transfer unit 620, a transmit beamforming vector determining unit 630, and a precoder 640.

The receiver 610 may obtain information that is associated with a first small effective channel that is formed between a first small terminal corresponding to a first small base station and a macro base station, and information that is associated with a second small effective channel that is formed between a second small terminal corresponding to a second small base station and a macro base station. In this example, the first macro effective channel may be associated with a receive beamforming vector of the first macro terminal and the second macro effective channel may be associated with a receive beamforming vector of the second macro terminal. The receiver 610 may receive information that is associated with channels that are formed between each of the first small base station and the second small base station, and each of the at least one macro terminal.

The transfer unit 620 may transfer, to the first small base station and the second small base station, information that is associated with the channels that are formed between each of the first small base station and the second small base station and each of the at least one macro terminal. The first small base station and the second small base station may use the information to determine the transmit beamforming vector of the first small base station and the transmit beamforming vector of the second small base station, respectively.

The transmit beamforming vector determining unit 630 may determine a transmit beamforming vector of the macro base station based on information that is associated with the first small effective channel and information that is associated with the second small effective channel.

The precoder 640 may perform precoding using the transmit beamforming vector of the macro base station which is determined by the transmit beamforming vector determining unit 630.

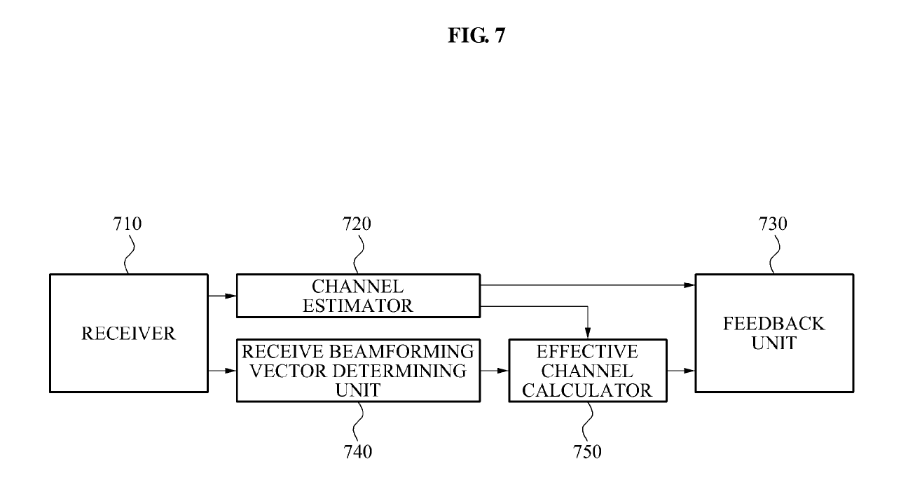

FIG. 7 illustrates an example of a macro terminal.

Referring to FIG. 7, the macro terminal includes a receiver 710, a channel estimator 720, a feedback unit 730, a receive beamforming vector determining unit 740, and an effective channel calculator 750.

The receiver 710 may receive a pilot from a first small base station and a second small base station. In this example, the receiver 710 may receive a demodulation reference signal (DM-RS) based on a transmit beamforming vector of each of the first small base station and the second small base station.

The channel estimator 720 may estimate a channel from each of the first small base station, the second small base station, and a macro base station, to the macro terminal. That is, the channel estimator 720 may estimate a channel formed between the first small base station and the macro terminal, may estimate a channel formed between the second small base station and the macro terminal, and may estimate a channel formed between the macro base station and the macro terminal. The channel estimator 720 may estimate an effective channel from each of the first small base station, the second small base station, and the macro base station, to the macro terminal, based on the receive beamforming vector of the macro terminal. The channel estimator 720 may estimate the effective channel from each of the first small base station and the second small base station based on the transmit beamforming vector of each of the first small base station and the second small base station.

The feedback unit 730 may feed back, to the macro base station, information that is associated with a first interference channel that is formed between the first small base station and the macro terminal, and a second interference channel formed between the second small base station and the macro terminal. In addition, the feedback unit 730 may feed back, to the macro base station, information that is associated with the effective channel formed between the macro base station and the macro terminal before the transmit beamforming vector of the macro base station is determined.

When the transmit beamforming vector of the first small base station and the transmit beamforming vector of the second small base station are determined, the receive beamforming vector determining unit 740 may determine the receive beamforming vector of the macro terminal.

The effective channel calculator 750 may calculate the effective channel that is formed between the macro base station and the macro terminal based on the receive beamforming vector of the macro terminal.

A macro base station, a macro terminal, and a communication method of the macro base station and the macro terminal are described herein. Descriptions made herein with reference to FIG. 1 through FIG. 3 are applicable to the macro base station, the macro terminal, and the communication methods of the macro base station and the macro terminal that are described with reference to FIGS. 4 through 7. Thus, further descriptions are omitted here.

Hereinafter, a method of generating a beamforming vector when interference from a small base station to a macro terminal is weak in a hierarchical cell communication system is described.

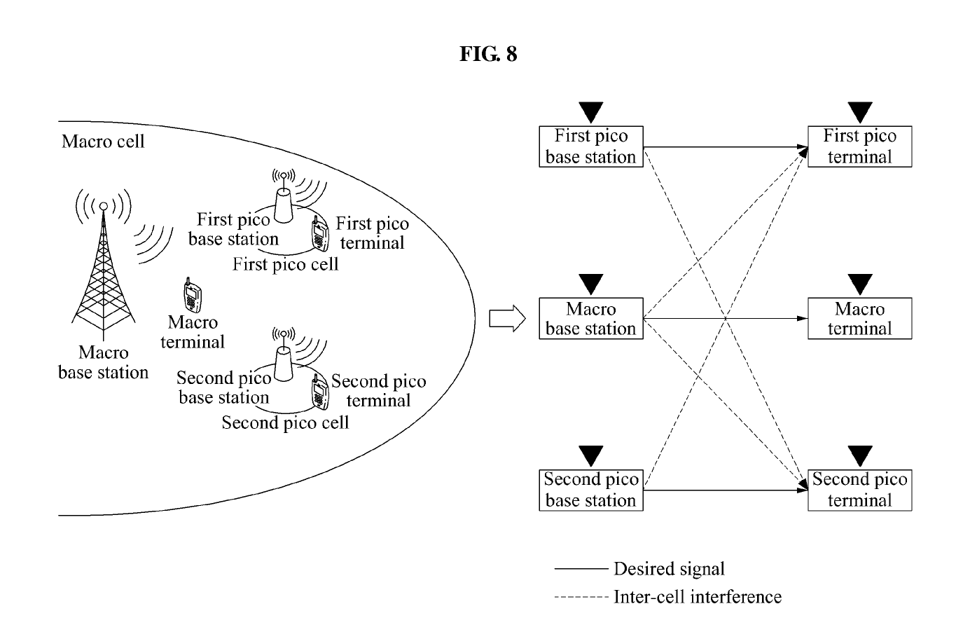

FIG. 8 illustrates an example of a hierarchical cell communication system in which interference from pico base stations to a macro terminal is weak.

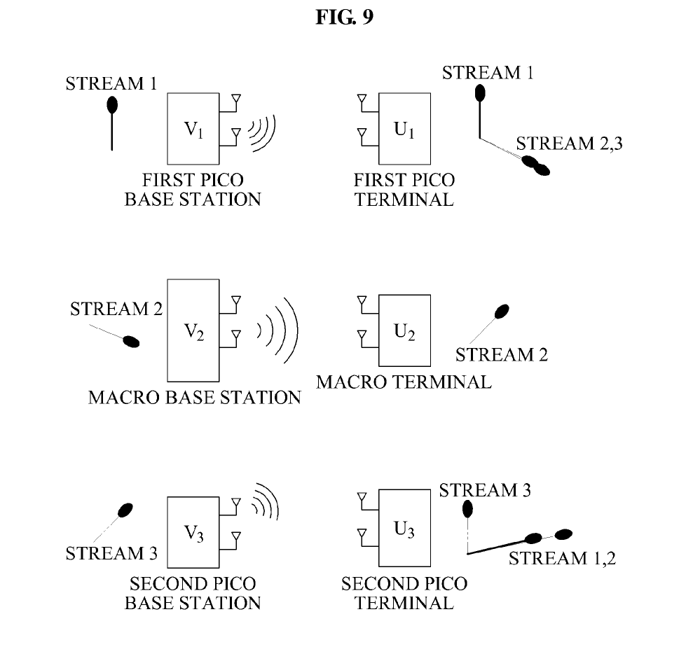

Referring to FIG. 8, a first pico cell and a second pico cell are present within a macro cell. A first pico base station included in the first pico cell serves a first pico terminal. A second pico base station included in the second pico serves a second pico terminal. In the hierarchical cell communication system of FIG. 8, interference from the first pico base station and the second base station to the macro terminal may be weak. A method of determining a beamforming vector in the above hierarchical cell communication system is further described with reference to FIG. 9.

FIG. 9 illustrates an example of a signal transmission process of a hierarchical cell communication system in which interference from pico base stations to a macro terminal is weak.

Referring to FIG. 9, the macro terminal receives relatively small interference from a first pico base station and a second pico base station. The above assumption may be realized when cooperative scheduling is performed such that the same frequency resource as pico cells may be assigned to the macro terminal that receives a relatively small amount of interference from the pico cells.

Even though a pico cell is used as an example, various aspects may be applicable to other small cells.

With the above assumption, the macro terminal may not receive interference and thus, may operate like communication performed in a unit cell.

For example, a signal transmitted by each base station for each terminal may be expressed by Equation 11.

xᵢ=\sqrt{pᵢ}vᵢsᵢ [Equation 11]

In this example, i=1, 2, 3, and 1, 2, 3 corresponds to a first pico terminal, a macro terminal, and a second pico terminal, respectively. A principle of symbols used for the description of FIG. 9 is similar to the symbols used for the description of FIG. 1.

A signal y₁^{pico} received by the first pico terminal, a signal y₂^{macro} received by the macro terminal, and a signal y₃^{pico} received by the second pico terminal may be expressed by Equation 12, Equation 13, and Equation 14, respectively.

$$\begin{matrix}{y}_{1}^{pico} = {H}_{11} \sqrt{{p}_{1}} {v}_{1} {s}_{1} + \underbrace{{H}_{12} \sqrt{{p}_{2}} {v}_{2} {s}_{2}}_{{other \text{-} cell interference}_{( Macro )}} + \underbrace{{H}_{13} \sqrt{{p}_{3}} {v}_{3} {s}_{3}}_{{other \text{-} cell interference}_{( Pico )}} + {n}_{1} & [ Equation 12 ] \\ {y}_{2}^{macro} = {H}_{22} \sqrt{{p}_{2}} {v}_{2} {s}_{2} + {n}_{2} & [ Equation 13 ] \\ {y}_{3}^{pico} = {H}_{33} \sqrt{{p}_{3}} {v}_{3} {s}_{3} + \underbrace{{H}_{32} \sqrt{{p}_{2}} {v}_{2} {s}_{2}}_{{other \text{-} cell interference}_{( Macro )}} + \underbrace{{H}_{31} \sqrt{{p}_{1}} {v}_{1} {s}_{1}}_{{other \text{-} cell interference}_{( Pico )}} + {n}_{4} & [ Equation 14 ]\end{matrix}$$

Each terminal may obtain an effective signal based on a receive beamforming vector uᵢ^{H} of each terminal.

For example, a process of determining transmit beamforming vectors and receive beamforming vectors of a macro cell and pico cells in the system model of FIG. 9 is described.

First, a macro base station may schedule the pico cells and a macro terminal that is not receiving interference from the pico cells among macro terminals.

Second, the macro terminal may measure a channel from the macro base station to the macro terminal, and may determine an optimal transmit beamforming vector v₂ and a receive beamforming vector u₂ in a unit cell aspect. In the example of a unit cell terminal that is not receiving inter-cell interference, the optimal transmit beamforming vector and the receive beamforming vector in a capacity aspect may be determined according to Equation 15.

$${v}_{2} = {v}_{1}^{[ 22 ]} , {u}_{2} = {u}_{1}^{[ 22 ]} where \\ {H}_{22} = {U}^{H} Σ V ( SVD decomposition ) = {{[ \begin{matrix}{u}_{1}^{[ 22 ]} & {u}_{2}^{[ 22 ]}\end{matrix} ]}^{H} [ \begin{matrix}{λ}_{1}^{[ 22 ]} & 0 \\ 0 & {λ}_{2}^{[ 22 ]}\end{matrix} ] [ \begin{matrix}{v}_{1}^{[ 22 ]} & {v}_{2}^{[ 22 ]}\end{matrix} ]}^{H} \qquad [ Equation 15 ]$$

Third, the macro terminal may feed back the transmit beamforming vector v₂ of the macro base station to the macro base station via an uplink channel. In this example, the macro terminal may feed back the transmit beamforming vector v₂ of the macro base station to the macro base station using a preferred matrix index (PMI) such as a method of using a unit cell codebook.

Fourth, the macro base station may transmit information that is associated with the transmit beamforming vector v₂ of the macro base station to a first pico terminal and a second pico terminal. For example, the macro base station may transmit a v₂ precoded DM-RS to the first pico terminal and the second pico terminal, or may feed forward, to the first pico base station and the second pico base station via an X2 interface, information that is associated with v₂ and information that is associated with an interference channel from the macro base station to each of the first pico terminal and the second pico terminal.

Fifth, each of the first pico terminal and the second pico terminal may recognize a signal space in which effective interference from the macro base station is received. The first pico terminal may determine a transmit beamforming vector v₃ of the second pico base station and a receive beamforming vector u₁ of the first pico terminal that are capable of cancelling interference that is received at the first pico terminal, such that interference may be aligned in the corresponding signal space. Similarly, the second pico terminal may also determine v₁ and u₃ using the same method.

For example, based on the transmit beamforming vector v₂ of the macro base station, an interference channel that is formed from the macro base station, and an interference channel that is formed from a neighboring pico base station, the pico terminal may determine a transmit beamforming vector vⱼ of a neighboring pico base station and the receive beamforming vector uᵢ of the pico terminal as shown in Equation 16.

$${v}_{j} = \frac{{H}_{ij}^{- 1} ( {H}_{i 2} {v}_{2} )}{\vert {H}_{ij}^{- 1} ( {H}_{i 2} {v}_{2} ) \vert} , \\ where i , j ∈ \{ 1 , 3 \} , i \neq j \\ {u}_{i} = null ( {( {H}_{i 2} {v}_{2} )}^{H} ) \\ where null ( A ) is vector space contained in \\ left null space of A \qquad [ Equation 16 ]$$

In this example, a zero-forcing scheme is used as an example to completely cancel interference. It should also be appreciated that a receive beamforming vector may be determined based on interference or noise.

Sixth, the first pico terminal may transmit the transmit beamforming vector of the second pico base station using an uplink resource of the first pico terminal. For example, the second pico terminal may transmit the transmit beamforming vector of the first pico base station using an uplink resource of the second pico terminal. As an example, the first pico terminal and the second pico terminal may also directly transmit the transmit beamforming vector of the neighboring pico base station to the neighboring pico base station using an uplink coordinated multi-point (CoMP) scheme.

The above method may satisfy an interference alignment condition at the pico terminal while the macro cell uses the optimal transmit beamforming vector and the receive beamforming vector. For example, if a mobility of the macro terminal is great, or if the macro cell does not use the optimal transmit beamforming vector and the receive beamforming vector, the transmit beamforming vector of the macro base station may be arbitrarily determined. Other beamforming vectors of all the base stations and terminals may be determined by repeating fourth through sixth operations. In this example, all the base stations and terminals may use the same codebook.

An amount of channel information to be fed back with respect to a DOF is shown in

TABLE 2

| | | number of feedback |
|---|---|---|
| | DOF | information |
| TDMA(existing) | 2 | (2 × 2): three |
| TDMA + CoMP | 2 | (2 × 2): three |
| Hierarchical IA | 3 | (2 × 1): three |
| (Max-SINR/ZF) | | |
| Iterative IS(existing) | 3 | (2 × 2): six |

In various aspects, a hierarchical IA technology may have a relatively high DOF gain compared to a time division multiple access (TDMA) and a combined form of the TDMA and a CoMP. In addition, compared to iterative IA using full channel state information at the transmitter (CSIT), the hierarchical IA technology may achieve the same DOF with a significantly small amount of channel information feedback.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

The processes, functions, methods and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and non-transitory computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method of a macro base station, the communication method comprising:
obtaining information associated with a first small effective channel formed between a first small terminal corresponding to a first small base station and a macro base station;
obtaining information associated with a second small effective channel formed between a second small terminal corresponding to a second small base station and the macro base station; and
determining a transmit beamforming vector of the macro base station based on information associated with the first small effective channel and information associated with the second small effective channel,
wherein a receive beamforming vector of each of the at least one macro terminal is determined based on the transmit beamforming vector of the first small base station and the transmit beamforming vector of the second small base station.

2. The communication method of claim 1, wherein the determining comprises determining the transmit beamforming vector of the macro base station based on information associated with the first small effective channel and information associated with the second small effective channel, such that interference from the macro base station is nulled in each of the first small terminal and the second small terminal.

3. The communication method of claim 2, further comprising:
receiving information associated with a first macro effective channel formed between a first macro terminal and the macro base station, and information associated with a second macro effective channel formed between a second macro terminal and the macro base station,
wherein the first macro effective channel is associated with a receive beamforming vector of the first macro terminal and the second macro effective channel is associated with a receive beamforming vector of the second macro terminal, and the determining comprises determining the transmit beamforming vector of the macro base station based on information associated with the first macro effective channel and information associated with the second macro effective channel, such that interference from the macro base station caused by a signal for the second macro terminal is nulled in the first macro terminal and such that interference from the macro base station caused by a signal for the first macro terminal is nulled in the second macro terminal.

4. The communication method of claim 2, further comprising:
obtaining information associated with an effective channel that is formed between a neighboring macro terminal corresponding to a neighboring macro base station and the macro base station,
wherein the effective channel is associated with a receive beamforming vector of the neighboring macro terminal, and the determining comprises determining the transmit beamforming vector of the macro base station based on information associated with the effective channel formed between the macro base station and the neighboring macro terminal, such that interference from the macro base station to the neighboring macro terminal is nulled in the neighboring macro terminal.

5. The communication method of claim 1, wherein the receive beamforming vector of each of the at least one macro terminal is determined based on the transmit beamforming vector of the first small base station and the transmit beamforming vector of the second small base station, such that interference from the first small base station and the second small base station is nulled in each of the at least one macro terminal.

6. The communication method of claim 1, further comprising:
receiving information associated with channels formed between each of the first small base station and the second small base station and each of the at least one macro terminal; and
transferring, to the first small base station and the second small base station, information associated with the channels formed between each of the first small base station and the second small base station and each of the at least one macro terminal.

7. A communication method of a macro terminal corresponding to a macro base station, the communication method comprising:
feeding back information associated with a first interference channel formed between a first small base station and the macro terminal, and a second interference channel formed between a second small base station and the macro terminal;
determining a receive beamforming vector of the macro terminal based on a transmit beamforming vector of the first small base station and a transmit beamforming vector of the second small base station;
calculating an effective channel formed between the macro base station and the macro terminal based on the receive beamforming vector of the macro terminal; and
feeding back, to the macro base station, information associated with the effective channel formed between the macro base station and the macro terminal.

8. The communication method of claim 7, wherein the feeding back comprises feeding back information in which information associated with the first interference channel and information associated with the second interference channel are combined.

9. The communication method of claim 7, wherein the feeding back comprises feeding back, to the macro base station, information associated with the first interference channel and the second interference channel such that information associated with the first interference channel and the second interference channel are transferred to the first small base station and the second small base station.

10. The communication method of claim 7, further comprising:
receiving information associated with the transmit beamforming vector of the first small base station and information associated with the transmit beamforming vector of the second small base station,
wherein the transmit beamforming vector of the first small base station and the transmit beamforming vector of the second small base station are determined such that interference from the first small base station and interference from the second small base station are aligned in the macro terminal.

11. The communication method of claim 7, wherein the determining comprises determining the receive beamforming vector of the macro terminal such that interference from the first small base station is cancelled in the macro terminal based on the transmit beamforming vector of the first small base station and the first interference channel, and such that interference from the second small base station is cancelled in the macro terminal based on the transmit beamforming vector of the second small base station and the second interference channel.

12. The communication method of claim 11, wherein the determining comprises determining the receive beamforming vector of the macro terminal to be orthogonal with respect to a direction of the interference from the first small base station and a direction of the interference from the second small base station.

13. A macro base station, comprising:
a receiver to obtain information associated with a first small effective channel formed between a first small terminal corresponding to a first small base station and a macro base station, and to obtain information associated with a second small effective channel formed between a second small terminal corresponding to a second small base station and the macro base station; and
a transmit beamforming vector determining unit to determine a transmit beamforming vector of the macro base station based on information associated with the first small effective channel and information associated with the second small effective channel,
wherein a receive beamforming vector of each of the at least one macro terminal is determined based on the transmit beamforming vector of the first small base station and the transmit beamforming vector of the second small base station.

14. The macro base station of claim 13, wherein the transmit beamforming vector determining unit is configured to determine the transmit beamforming vector of the macro base station based on information associated with the first small effective channel and information associated with the second small effective channel, such that interference from the macro base station is nulled in each of the first small terminal and the second small terminal.

15. The macro base station of claim 14, wherein:
if the at least one macro terminal comprises a first macro terminal and a second macro terminal, the receiver is configured to receive information associated with a first macro effective channel formed between the first macro terminal and the macro base station, and information associated with a second macro effective channel formed between the second macro terminal and the macro base station, the first macro effective channel is associated with a receive beamforming vector of the first macro terminal and the second macro effective channel is associated with a receive beamforming vector of the second macro terminal, and
the transmit beamforming vector determining unit is configured to determine the transmit beamforming vector of the macro base station based on information associated with the first macro effective channel and information associated with the second macro effective channel, such that interference from the macro base station occurring due to a signal for the second macro terminal is nulled in the first macro terminal and such that interference from the macro base station occurring due to a signal for the first macro terminal is nulled in the second macro terminal.

16. The macro base station of claim 14, wherein:
the receiver is configured to obtain information associated with an effective channel formed between a neighboring macro terminal corresponding to a neighboring macro base station and the macro base station, and the effective channel is associated with a receive beamforming vector of the neighboring macro terminal, and
the transmit beamforming vector determining unit is configured to determine the transmit beamforming vector of the macro base station based on information associated with the effective channel formed between the macro base station and the neighboring macro terminal, such that interference from the macro base station to the neighboring macro terminal is nulled in the neighboring macro terminal.

17. The macro base station of claim 15, wherein the receive beamforming vector of each of the at least one macro terminal is determined based on the transmit beamforming vector of the first small base station and the transmit beamforming vector of the second small base station, such that interference from the first small base station and the second small base station is nulled in each of the at least one macro terminal.

18. The macro base station of claim 13, wherein:
the receiver is configured to receive information associated with channels formed between each of the first small base station and the second small base station and each of the at least one macro terminal, and
the macro base station further comprises:
a transfer unit to transfer, to the first small base station and the second small base station, information associated with the channels formed between each of the first small base station and the second small base station and each of the at least one macro terminal.

19. A communication method of a targeted small terminal corresponding to a targeted small base station, the communication method comprising:
obtaining information associated with an effective channel from a macro base station to the targeted small terminal based on a transmit beamforming vector of the macro base station, and information associated with a channel from a neighboring small base station to the targeted small terminal;
determining a transmit beamforming vector of the neighboring small base station such that interference from the macro base station and interference from the neighboring small base station are aligned in the targeted small terminal; and
determining a receive beamforming vector of the targeted small terminal such that interference from the macro base station is nulled in the targeted small terminal.

20. The communication method of claim 19, wherein:
the determining of the transmit beamforming vector of the neighboring small base station comprises determining the transmit beamforming vector of the neighboring small base station based on the same codebook as a codebook used to generate the transmit beamforming vector of the macro base station, and
the determining of the receive beamforming vector of the targeted small base station comprises determining the receive beamforming vector of the targeted small terminal based on the same codebook as the codebook used to generate the transmit beamforming vector of the macro base station.
